(19) United States
(12) Patent Application Publication
(10) Pub. No.: US 2006/0294043 A1
(43) Pub. Date: Dec. 28, 2006

(54) System and method for promoting reliability in attendance at events

(76) Inventor: Firinn Taisdeal, Walnut Creek, CA (US)

Correspondence Address: THOMPSON & THOMPSON, P.A., P.O BOX 166, SCANDIA, KS, 66966, US

(21) Appl. No.: 11/165,999

(22) Filed: Jun. 24, 2005

(51) Int. Cl. G06F 17/30

(52) U.S. Cl. 707/1

(57) ABSTRACT

A system and method are disclosed for scheduling events and for promoting reliability in attendance at events. The system communicates with members through a computer network and allows members to create and host events and to add themselves to guest lists for events hosted by other members. The system includes a database containing information about each member using the system, including the member's history of adding themselves to guest lists for events, removing themselves from such guest lists, failing to attend events, and submitting unacceptable excuses for failing to attend events. The system calculates a reliability rating for each member based on the information contained in the database. The host of an event can set a reliability threshold for attending the event, and the system will prevent members having a calculated reliability rating lower than the threshold from adding themselves to the guest list for the event.

### BACKGROUND OF THE INVENTION

1. Field of the Invention

The present invention relates generally to event management systems and methods. In particular, the present invention relates to systems and methods for scheduling events and promoting reliability in attendance at such events.

2. Description of the Related Art

Managing an event, such as a group meal, cultural activity, movie, sports event, and the like, often requires a substantial investment of time, energy and/or money by the host of the event for planning, scheduling and coordinating the event. The host often needs or wants an accurate head count for the event for planning purposes (e.g., for seating arrangements, meal preparations, tickets, etc.). This is true for events having a small number of participants, as well as large events. Hosts put considerable time, effort and care into their events, and therefore want to be able to count on their guests to attend. Unfortunately, the reality is that guests on an invitation list often fail to show up for events, or cancel their reservations at the last-minute. This behavior is not only rude and selfish, but also tends to undermine the confidence in the events and in each other for the people using the system.

Feedback systems have been developed for use with person-to-person electronic commerce, particularly on-line private party auction web sites. These feedback systems are usually provided by the auction web site and allow person-to-person transaction participants to provide feedback on their transaction partners. Satisfied participants are expected to rate each other highly, while dissatisfied participants can rate each other poorly. Other participants on the auction web site can then use these ratings to gauge the trustworthiness of someone they have not done business with themselves. These subjective feedback systems sometimes have questionable validity because of the potential for collusion, animosity, and quid pro quo scenarios that can affect the ratings. In an effort to overcome these problems, an automated data-based reputation characterization system has been described in U.S. Pat. No. 6,856,963 by Hurwitz.

However, the feedback systems described above are not used in conjunction with systems for creating and managing events, and do not promote reliability and predictability in attendance at events.

### SUMMARY OF THE INVENTION

An object of the present invention is to provide a system and method for scheduling events of any kind, and for promoting reliability and therefore predictability in attendance at such events.

A further object of the present invention is to provide a system and method that offers hosts of events a choice as to the demonstrated reliability of guests at such events.

In order to accomplish these and other objects of the invention, a system and method are disclosed for scheduling events and managing guest lists for the events in a manner that promotes reliability and predictability in attendance at the events. The system communicates with members through a computer network, such as the Internet, and allows members to create and host events and to add themselves to guest lists for events hosted by other members.

The system includes a database containing information about each member using the system, including the member's history of adding themselves to guest lists for events, removing themselves from such guest lists, failing to attend events, and submitting unacceptable excuses for failing to attend events. The system calculates a reliability rating for each member based on the information contained in the database. Negative behavior patterns, such as signing up for an event and then not showing up for the event, or signing up for an event and then canceling for the event close to the date of the event, result in a lower calculated reliability rating. The host of an event can set a reliability threshold for attending the event, and the system will prevent members having a calculated reliability rating lower than the set threshold from adding themselves to the guest list for the event.

The present invention provides in one aspect, a system for promoting reliability in attendance at events, comprising: a means for adding a person to a guest list for an event; a means for removing a person from the guest list; a database containing history of use information for each person using the system; a means for calculating a reliability rating for a person based on information contained in the database; and a means for using the reliability rating to determine whether a person is allowed to be added to a guest list for an event.

In another aspect, the present invention provides a computer program for use with a computer system to manage guest lists for events, comprising: a means for adding a person to a guest list for an event; a means for removing a person from the guest list; a means for accessing a database containing personal profiles of people using the system; a means for calculating a reliability rating for a person based on information in the personal profiles contained on the database; and a means for using the calculated reliability rating to determine whether a person is allowed to be added to a guest list for an event.

In another aspect, the present invention provides a method of managing guest lists for events, comprising: receiving requests by persons desiring to be added to a guest list for an event; receiving requests by persons desiring to be removed from the guest list; maintaining a database containing history of use information for each person using the system; calculating a reliability rating for a person based on the history of use information maintained on the database; and using the calculated reliability rating to determine whether a person is allowed to be added to a guest list for an event.

Numerous other objects and features of the present invention will be apparent to those skilled in this art from the following description wherein there is shown and described embodiments of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a network diagram of a system for managing guest lists and promoting reliability in attendance at events according to the present invention.

FIG. 2 is a detail view of the personal profile fields used in the database of the present invention.

FIG. 3 is a detail view of the event information fields used in the database of the present invention.

FIG. 4 is a block diagram flow chart showing the process used by the system of the present invention to calculate a member's reliability rating.

FIG. 5 is a block diagram flow chart showing the process used by a host to set up an event.

FIG. 6 is a block diagram flow chart showing the process used by a member to RSVP for an event.

FIG. 7 is a block diagram flow chart showing the process used by the system of the present invention to manage a guest list for an event.

FIG. 8 is a block diagram flow chart showing the process used by the system of the present invention to remove a member from a guest list for an event.

FIG. 9 is a block diagram flow chart showing the process used by a host to remove a member from a guest list for an event.

### DETAILED DESCRIPTION OF THE INVENTION

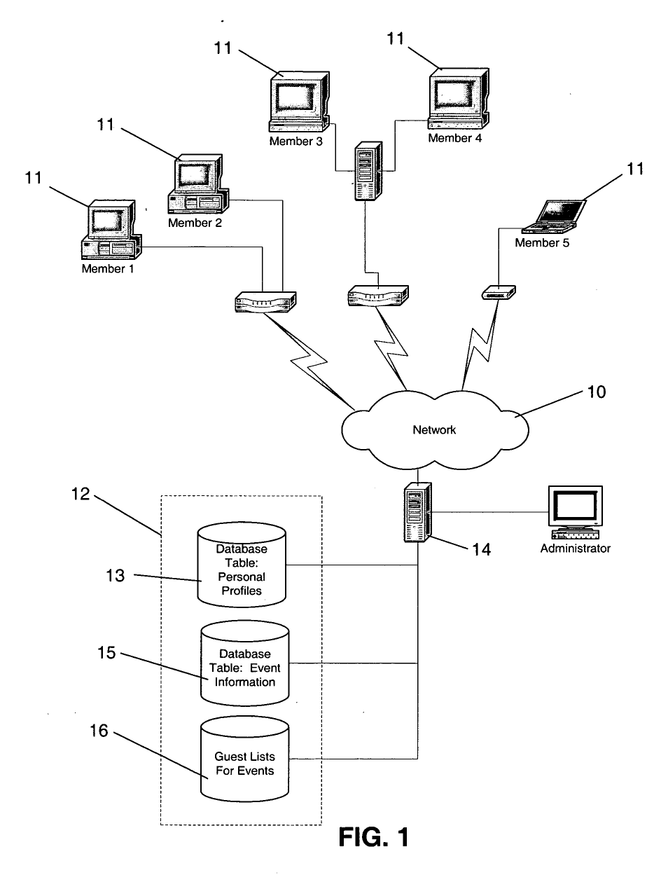

A system and method for scheduling events and managing guest lists according to the present invention will be explained in detail below with reference to FIGS. 1 to 9 of the accompanying drawings.

In the following description, the term “member” will be used to describe the various people using the system. A member can be a guest of an event, a host of the event, and/or a person viewing or using the system who has not yet attended or hosted an event. Although the invention can be limited to members of a select group of people or paying subscribers for a particular service, the “members” using the present invention and referred to in the following description are not limited to any such groups of people. The term “RSVP” will be used in the following description to refer to requests by members to be added to a guest list for an event.

The present invention provides a system for locating and cultivating people, relationships, ideas and experiences. The invention can be used by members (1) to find an event of interest, RSVP for the event, and attend the event, and/or (2) to create and host an event for other members to attend. The invention helps makes management of events easy and convenient, and allows a wide variety of events to be hosted by members. For example, group meals, cultural activities, outdoor activities, mixers, movies, sports events, travel, and volunteer activities can be created and hosted by members using the system of the present invention.

The invention encourages individual as well as group creativity, shared experience, integrity, and courtesy. The invention also emphasizes reliability and accountability, which helps members have confidence in each other, and have confidence that their time will not be wasted by people not showing up for an event. The invention discourages rude and inconsiderate behavior by the members.

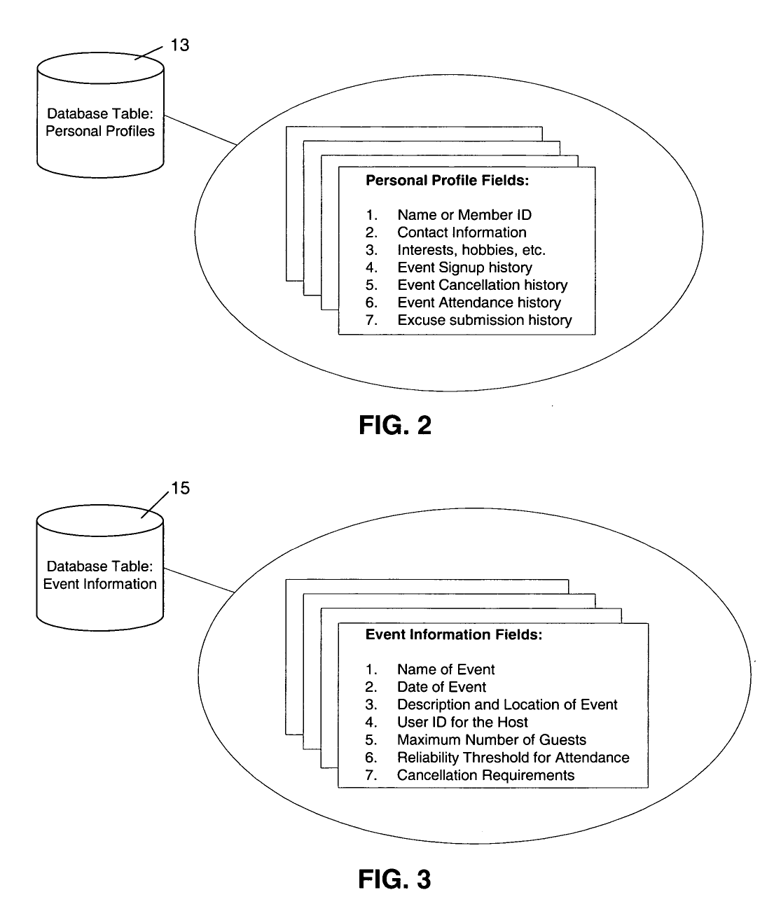

In an exemplary embodiment, the present invention uses a network 10 of computers 11 to communicate with individual members, and a database 12 containing personal profiles about the members. The personal profiles are contained in a database table 13 on the database 12 and include, among other things, the name or user ID for the member, contact information (e.g., E-mail address), some interests or hobbies of the member, and a history of use of the system by the member. Such history of use information includes the member's history of adding himself or herself to guest lists for events (i.e., signups), removing himself or herself from such guest lists (i.e., cancellations), failing to attend events (i.e., no-shows), and submitting unacceptable excuses for failing to attend events (i.e., lame excuses). As depicted in FIG. 2, the personal profile information is contained in separate fields for each member on the personal profile database table. Alternatively, the history of use information for each member can be stored in a separate table on the database 12. A microprocessor residing on a server 14, for example, is used for storing and retrieving information from the database 12.

The network 10 of computers 11 used to communicate with individual members can be, for example, a wide area network, such as the Internet, a metropolitan area network, a local area network, or another well known network configuration. The members can be, for example, a group of individuals living in a particular metropolitan area or geographic region (e.g., the San Francisco Bay Area) who have subscribed to the service provided by the present invention. Alternatively, the members can be located throughout several urban or geographic regions, states, and even multiple continents. The features of the present invention are applicable without limitation as to the particular group of persons using the invention, and without limitation as to the particular network configuration used by members to communicate with the system.

The database 12 also contains information about various events that have been created by members, which are available for other members to attend. The event information is contained in a database table 15 on the database 12 and includes, for example, the name of the event, the date and time of the event, a description and location of the event, the name of the host member, a maximum number of guests allowed to RSVP for the event, a reliability threshold (explained below) for attending the event, and any cancellation requirements set by the host member. As depicted in FIG. 3, this event information for each event is contained in separate fields on the event information database table 15.

To promote reliability by the members, and therefore predictability in attendance at events, the present invention calculates a reliability rating for each member based on the history of use information contained in the database. Negative behavior patterns, such as signing up for an event and then not showing up for the event, or signing up for an event and then canceling for the event close to the date of the event, or submitting a lame excuse for failing to attend an event, result in a lower calculated reliability rating. Such negative behavior patterns are quantified by the present invention by adding a “demerit” to a member's personal profile each time the negative behavior pattern occurs. The host of an event can set a reliability threshold for attending the event, and the system will prevent members having a calculated reliability rating lower than the set threshold from adding themselves to the guest list 16 for the event.

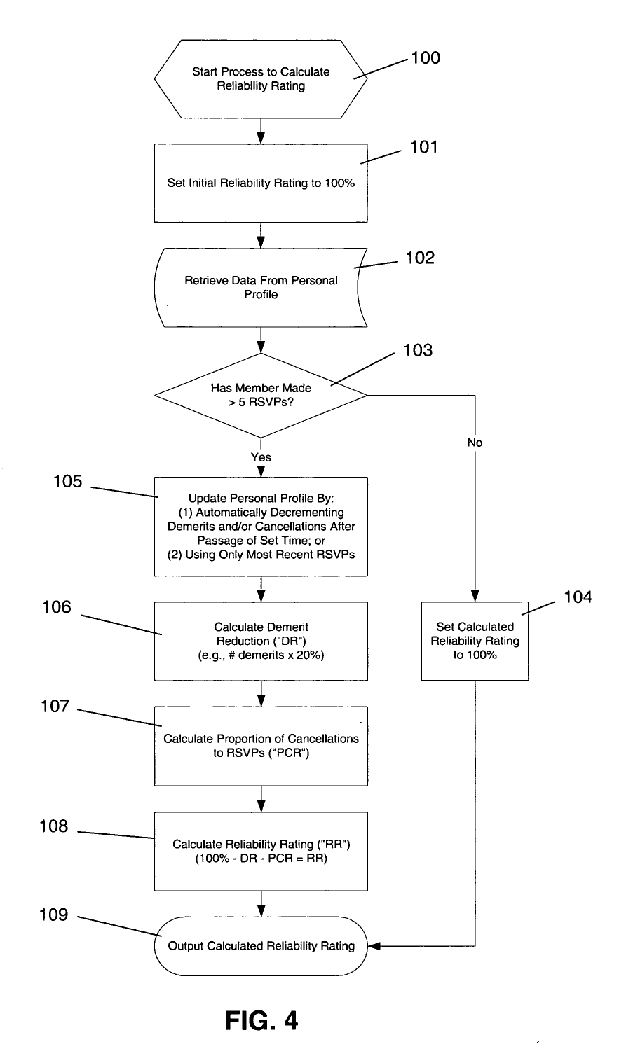

FIG. 4 shows an exemplary embodiment of the process used by the present invention to calculate reliability ratings for the members. The process starts at step 100 and can be run, for example, each time a member attempts to RSVP for an event. Alternatively, the process shown in FIG. 4 can be run at scheduled times or each time information is received by the system that would affect the calculation. At step 101, the process sets an initial reliability rating for each member at 100%. That is, the process assumes 100% reliability for each member until indications emerge to the contrary. The assumption of 100% reliability can be kept in place for the first five RSVPs, for example. In other words, the reliability rating of each member is to-be-determined, but functions as if it is 100% until the system gathers enough information for patterns to be apparent. In step 102, the process retrieves data from the personal profile table 13 in the database 12 for the subject member. In step 103, the process determines whether the member has made more than the set minimum number (e.g., 5) of RSVPs. If not, the process moves to step 104 and sets the calculated reliability rating to 100% for the member, and allows the member to RSVP for events without limitation as to the reliability thresholds set by the hosts of the events.

Once the member has exceeded the set minimum number of RSVPs (e.g., 5), the process proceeds to a series of steps 105-108 used to calculate the member's reliability rating based on the member's history of use of the system. In step 105, the process updates the member's history of use information contained in the member's personal profile. This updating step 105 can be used to erase a member's behavioral history gradually over time to allow members to adapt to the system and gradually rise back up to 100% reliability if they adjust their behavior appropriately. For example, one cancellation per month and one “demerit” per quarter can be decremented from the member's personal profile. In this example, even someone with six cancellations and two demerits would be able to rise back up to a 100% reliability rating in six months.

Another example of automatically updating a member's history of use information in step 105 is to base the reliability rating calculation on only the most recent RSVPs (e.g., the most recent ten RSVPs). In this example, a table to the database would record RSVPs and cancellations, with each record stamped with date and time. Both RSVPs and cancellations would be stored as individual records in the table. When calculating a reliability rating, the system would perform a database query with a limit of 10 records, sorted in reverse chronological order. The system would then read the date of the least recent RSVP, and perform another search for cancellations more recent than that date to establish the proportion of cancellations to RSVPs for that chronological window. Any demerits would also be rolled into this calculation.

After the automatic updating step 105 described above, the process moves to step 106 and calculates a demerit reduction (“DR”) for use in the reliability calculation. In one example, the DR is determined by multiplying the number of demerits contained in the member's personal profile by 20% (i.e., each demerit knocks the reliability rating percentage down by 20%). As mentioned above, a demerit is added to the member's personal profile for each no-show, last minute cancellation, lame excuse, and possibly other predetermined behavior patterns that reflect negatively on the member's reliability. If each demerit results in a 20% reduction in the calculated reliability rating, it would take a total of five demerits for a member to reach a reliability rating of 0%.

In step 107, the process calculates a proportion of cancellations to RSVPs. This proportion, referred to herein as PCR, is used to address the issue of habitual cancellers, and people who see an RSVP as a bookmark, instead of a social commitment. Thus, if a member sends in ten RSVPs, but then cancels for five of those events, no matter how long before the event, the member's reliability rating would be 50% (5 divided by 10), not counting any demerits.

In step 108, the process calculates a reliability rating (RR) for each member by subtracting the demerit reduction (DR) and the proportion of cancellations to RSVPs (PCR) from the starting reliability rating of 100%. In other words, the following formula is used:
100%−DR−PCR=RR

Some examples of reliability rating calculations using this formula will now be given:
1. Assume a total of ten RSVPs, five cancellations, and one demerit. The member's reliability rating would be 30% (down 20% from the one demerit, and down another 50% from the ratio of cancellations to RSVPs);
2. Assume a total of ten RSVPs, one cancellation, and two demerits. The member's reliability rating would be 50% (down 40% from the two demerits, and down another 10% from the ratio of cancellations to RSVPs).

Of course, other weighting factors can be used to give the demerits more or less weight relative to each other and relative to the proportion of cancellations to RSVPs in the reliability rating calculation. As explained below, the calculated reliability rating (RR) is made available in step 109 to other process steps of the present invention to restrict members having low reliability ratings from attending certain events.

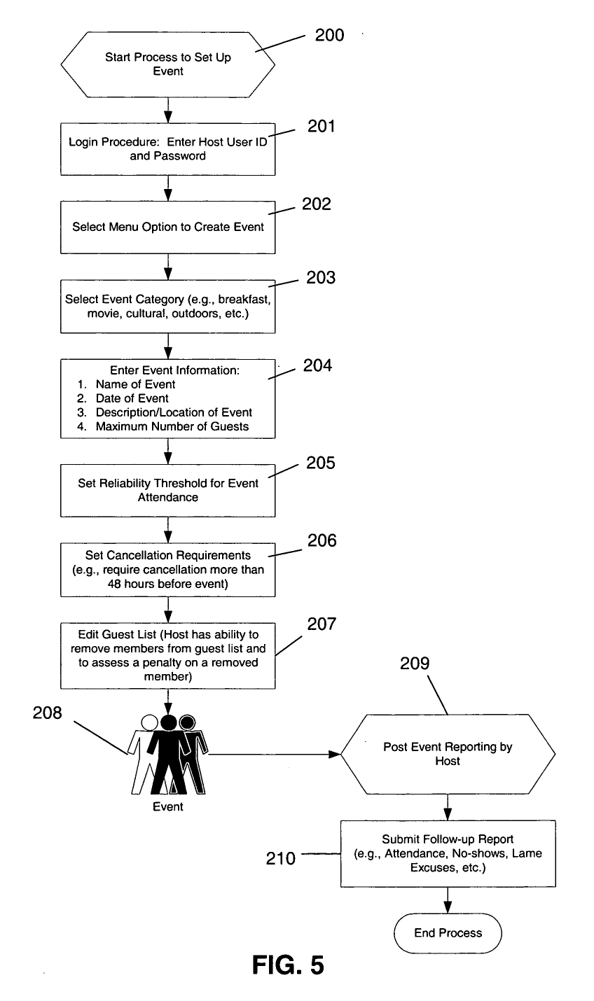

A member can create an event using the process steps shown in FIG. 5. The process for setting up an event starts at step 200 upon being initiated by a member who wants to create and host an event. In step 201, the member logs into the system, and in step 202, the member selects a menu option to create an event (the member becomes the “host” of that event). The host member then selects a category matching the event from a list of menu options in step 203. For example, the host member can chose from a menu of category options, including breakfast, lunch, dinner, culture, outdoors, mixers, movies, singles, spirit, sports, travel, and volunteer. The process then moves to step 204 and asks the host member to enter specific information about the event, including the name of the event, date of the event, description and location of the event, and the maximum number of guests that the host will allow to RSVP for the event. The system tailors the questionnaire used to collect information for creating the event to match the event category chosen by the host member in step 203.

In step 205, the host member can set a reliability threshold that other members must meet or exceed to RSVP for the event. In step 206, the host member can set the desired cancellation requirements. For example, the host member can require other members to submit any cancellations for the event at least 48 hours before the event to avoid a negative impact on the members' reliability ratings.

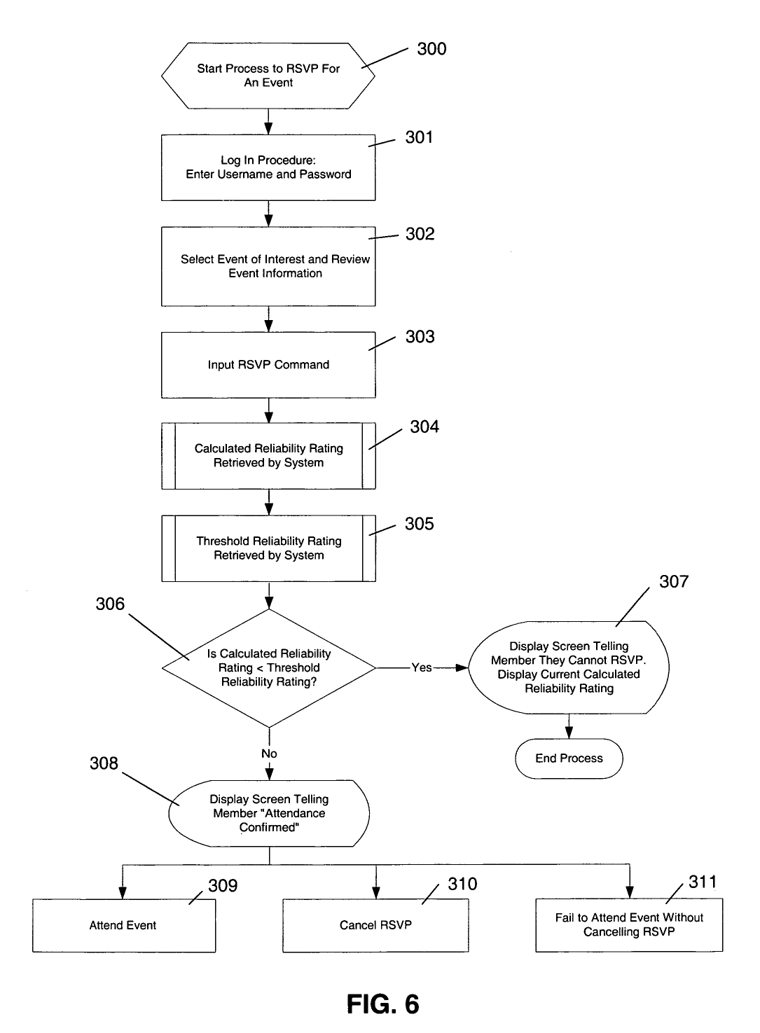

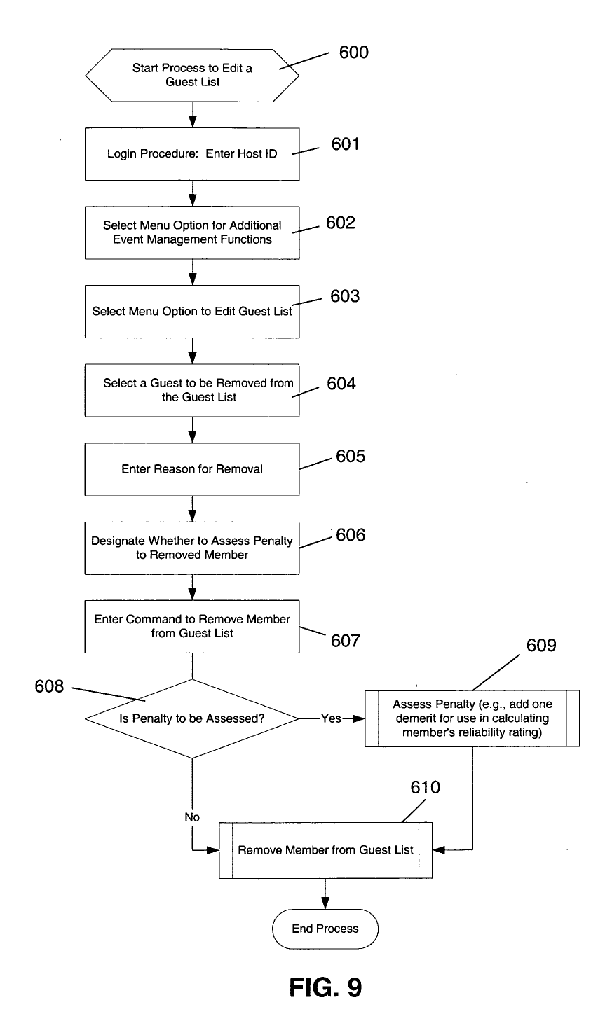

Once the event has been created by the host member, a notice of the event is posted on a website, bulletin board, or otherwise made available for other members to review and decide whether they want to attend. Those members wanting to attend the event can then RSVP for the event, using the process described below and shown in FIG. 6. The host member is then given the option in step 207 of editing the guest list for the event by removing one or more of the members from the guest list. The process of editing the guest list is explained in more detail below with reference to FIG. 9.

The actual event occurs at step 208, and the system then presents the host member in step 209 with the option of submitting a follow-up report with information regarding the event after the event occurs. The host member submits the follow-up report in step 210, which provides the system with information regarding the attendance at the event, the no-shows for the event, those submitting lame excuses, and so forth. This information is then matched with the personal profiles of the affected members, stored in the database, and used to calculate reliability ratings for future use.

A member can RSVP for an event using the process shown in FIG. 6. The process starts at step 300 upon being initiated by a member who wants to submit an RSVP and attend an event. In step 301, the member first goes through a login procedure. In step 302, the member then selects an event of interest from a screen of menu options. The system then displays additional information about the event for review by the member. If the member is interested in attending the event, the member can then choose an RSVP menu option in step 303 to add his or her name to the guest list for the event.

The system then calculates a reliability rating for the member in step 304 using the process described above and shown in FIG. 4, or the system retrieves a previously calculated reliability rating from the database 12 for the member.

In step 305, the system retrieves the threshold reliability rating, if any, set by the host for the event. In step 306, the system compares the calculated reliability rating with the threshold reliability rating to determine if the member is allowed to RSVP for the event. If the member's calculated reliability rating is less than the threshold reliability rating, then the process moves to step 307 and displays a screen advising the member that he or she cannot RSVP for the event, and also displays the current calculated reliability rating for the member. If the member's calculated reliability rating is equal to or greater than the threshold reliability rating, then the process moves to step 308 and displays a screen advising the member that the RSVP has been accepted (e.g., “Attendance Confirmed”).

Once a member has submitted an RSVP and the RSVP has been accepted, the member can (and should) attend the event at the scheduled time, as indicated in step 309. Attendance at the event may help the member locate and cultivate new people, relationships, ideas and/or experiences. Attendance will also reflect positively on the member's reliability rating for attending future events.

However, the member's schedule may change unexpectedly, or the member may change his or her mind regarding the event, or a variety of other reasons might arise that make the member want or need to cancel his or her RSVP for the event. To accomplish this, the member can log onto the system again and select a menu option to cancel the RSVP, as indicated in step 310. If the cancellation is received only a short time before the event (e.g., less than 48 hours), and the host has elected to penalize such last minute cancellations, the cancellation will result in a “demerit” being added to the cancelling member's personal profile. On the other hand, if the cancellation request is received well in advance of the event (e.g., more than 48 hours before), or if the host has elected not to penalize any cancellations, only the cancellation will be recorded in the member's personal profile. In either case, the member's calculated reliability rating for future events will be reduced according to the process described above and shown in FIG. 4.

Another possibility is that the member will simply fail to attend the event without cancelling his or her RSVP, as indicated in step 311. This is obviously considered a strongly negative behavior, which will result in a “demerit” being added to the cancelling member's personal profile and will count against the member's calculated reliability rating for future events.

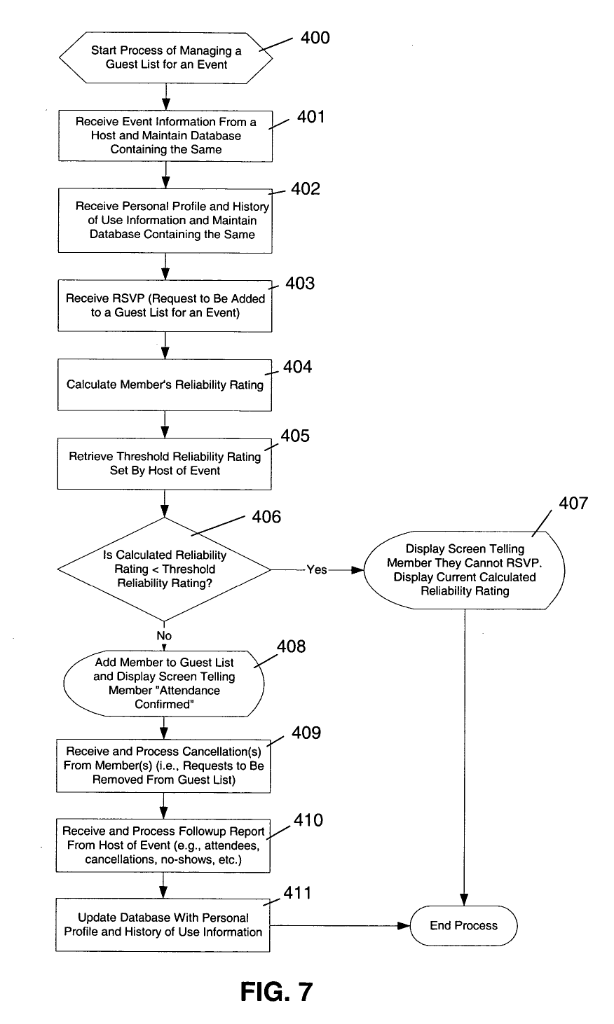

An example of a process used by the system of the present invention for managing a guest list for an event will now be described with reference to FIG. 7. The process receives event information from a host member in step 401, as described above and shown in FIGS. 3 and 5, and maintains a database containing the same, as shown in FIG. 1. The process also receives personal profile information and history of use information for each member in step 402, as described above and shown in FIGS. 2, 4 and 6, and maintains a database containing the same, as shown in FIG. 1. The process then receives RSVPs in step 403 from various members wanting to be added to a guest list for an event.

Upon receiving an RSVP, the member's reliability rating is calculated in step 404, and a threshold reliability rating set by the host of the event is retrieved in step 405. The calculated reliability rating is compared with the threshold reliability rating in step 406 to determine if the member is allowed to RSVP for the event. If the calculated reliability rating is less than the threshold reliability rating (i.e., the member's reliability is too low), the process moves to step 407 and the system will display a screen advising the member he or she cannot RSVP for the event, and will also display the member's current calculated reliability rating. If the calculated reliability rating is equal or greater than the threshold reliability rating (i.e., the member has a sufficiently high reliability), the process moves to step 408 and the system will add the member to the guest list for the event and display a screen advising the member that the RSVP has been accepted (e.g., “Attendance Confirmed”).

The system can then be used by the members in step 409 to receive and process cancellation requests from the members (i.e., requests to be removed from the guest list).

After a scheduled event, the process moves to step 410, and the system is used to receive and process follow-up reports from the host of the event. As explained above, the follow-up report is used for the host to report on the attendance at the event, the no-shows, the lame excuses, and so forth. The information from the follow-up report submitted by the host member is then used in step 411 to update the database 12 with additional personal profile and history of use information. The updated information on the database 12 will be used to calculate reliability ratings for use when the member tries to RSVP for future events.

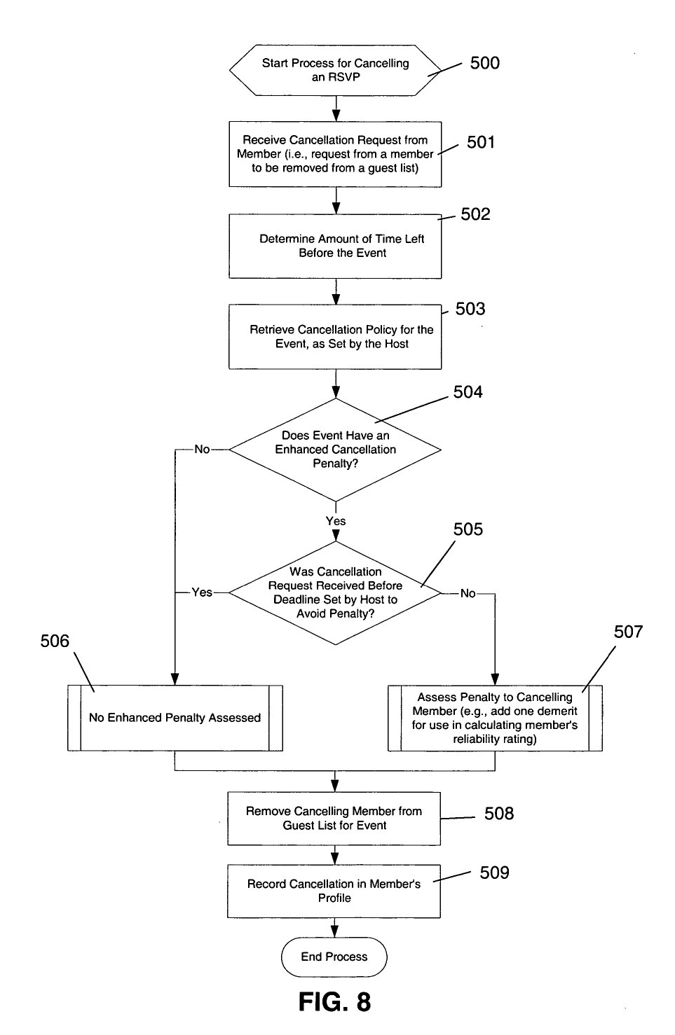

An example of a process used by the system of the present invention for removing a member from a guest list for an event will now be described with reference to FIG. 8. The process receives a cancellation request from a member in step 501 to be removed from a guest list for an event, as described above. The process then determines in step 502 the length of time before the event the cancellation request was received. As shown in step 503, the process retrieves from the database the cancellation policy for the event, as set by the host member for the event. For example, the host member may have set a cancellation policy requiring cancellations to be received at least 48 hours before the scheduled start time for the event to avoid having a demerit added to the cancelling member's history of use profile.

In step 504, the process determines whether the cancellation policy set by the host member includes an enhanced penalty for cancelling “at the last minute” or during a set time period before the event (e.g., less than 48 hours before the event). If the cancellation policy does not include such an enhanced penalty, the process skips step 505 and proceeds to step 506 where no enhanced penalty is assessed to the cancelling member. On the other hand, if the cancellation policy does include provisions for an enhanced penalty for late cancellations, the process proceeds to step 505 and determines whether the cancellation request was received before the deadline (e.g., 48 hours) set by the host member to avoid an enhanced penalty. If the cancellation was received before the deadline, then the process proceeds to step 506 where no enhanced penalty is assessed. If the cancellation was received after the deadline, then the process proceeds to step 507 where a penalty is assessed to the cancelling member. For example, one demerit may be added to the cancelling member's profile for use in calculating the member's reliability rating. In step 508, the process removes the cancelling member from the guest list for the event, and in step 509 the cancellation is recorded in the member's history of use profile for use in future reliability rating calculations.

An example of a process used by the system of the present invention for editing a guest list for an event will now be described with reference to FIG. 9. The host member goes through a login procedure as depicted by step 601, and then selects a menu option for additional event management functions in step 602. The host member then selects a menu option for editing a guest list in step 603, and selects a guest to be removed the guest list in step 604. The system requires the host member to enter a reason for removing the guest in step 605.

The host member is prompted in step 606 to designate whether to assess a penalty (e.g., one demerit) to the removed member, which will lower the member's calculated reliability rating. Examples of reasons for removing a member from the guest list and assessing a penalty include: (1) the removed member fails to cancel using the computer system, even though the member lets the host member know he or she won't be attending; (2) the removed member fails to respond to messages requiring a response; (3) the removed member fails to respond to a previous request that he or she cancel from the event; (4) the removed member fails to complete a required pre-payment for the event; (5) the removed member is simply not wanted at the event; and/or (6) any other reason the host member believes is valid and is ready to defend. The ability for the host member to remove a member from a guest list and assess a penalty is important to avoid the phenomenon of guests trying to beat the system by not canceling their RSVP using the computer system, but instead asking the host member directly to remove them from the guest list. Such members can still be assessed the penalty if the host member so designates in step 606 when removing the members from the guest list. This gives the host member the ability to assess a penalty if the host member believes the cancelling member is operating in bad faith, trying to beat the system, or is otherwise being inconsiderate.

The host member then enters the command in step 607 to remove the member from the guest list. The system determines in step 608 if a penalty is to be assessed, and if so, the process goes to step 609 and assesses the penalty. The process then goes to step 610 and removes the selected member from the guest list for the event. If the host member did not designate a penalty to be assessed, then the process goes directly from step 608 to step 610 and removes the selected member from the guest list.

It will be appreciated that certain features of the present invention described above can be changed without departing from the scope of the invention. For example, the particular weighting given to the various negative behavior patterns in the reliability rating calculation can be changed (e.g., a last minute cancellation could result in a 10% reduction in the member's reliability rating, and a no-show for an event could result in a 30% reduction in the reliability rating).

While the invention has been specifically described in connection with specific embodiments thereof, it is to be understood that this is by way of illustration and not of limitation, and the scope of the appended claims should be construed as broadly as the prior art will permit.

What is claimed is:

1. A system for promoting reliability in attendance at events, comprising:
a means for adding a person to a guest list for an event;
a database containing history of use information for each person using the system;
a means for calculating a reliability rating for a person based on information contained in the database; and
a means for using said reliability rating to determine whether a person is allowed to be added to a guest list for an event.

2. The system according to claim 1, further comprising a means for removing a person from a guest list.

3. The system according to claim 2, wherein said database comprises a profile table having fields for recording a person's history of adding themselves to guest lists for events, removing themselves from such guest lists, and failing to attend such events.

4. The system according to claim 2, wherein said means for adding a person to a guest list for an event comprises a means by which the person can add himself or herself to the guest list.

5. The system according to claim 2, wherein said means for removing a person from the guest list comprises a means by which the person can remove himself or herself from the guest list after having expressed an intent to attend the event.

6. The system according to claim 5, further comprising a means for determining how much time before an event a person removed himself or herself from the guest list for that event.

7. The system according to claim 2, further comprising a means for a host of an event to set a particular length of time before the event after which a person on the guest list cannot remove his or her name from the guest list without receiving a greater negative impact on his or her reliability rating.

8. The system according to claim 1, wherein said means for using said reliability rating comprises a means for comparing the calculated reliability rating with a reliability threshold set by a host of the event.

9. The system according to claim 1, wherein said means for using said reliability rating comprises a means for preventing persons with a low reliability rating from adding themselves to a guest list for an event.

10. The system according to claim 1, further comprising a means for setting a reliability threshold for an event, and wherein said means for using said reliability rating comprises a means for comparing the calculated reliability rating for each person with said reliability threshold and preventing those persons having a reliability rating lower then said reliability threshold from adding themselves to the guest list for the event.

11. The system according to claim 1, wherein said database comprises a profile table having a field for recording a person's history of submitting an excuse considered unacceptable by a host of an event for failing to attend the event.

12. The system according to claim 1, wherein said database further comprises an event table containing information about an event, including a name of the event, date of the event, and description of the event.

13. The system according to claim 1, wherein said means for calculating a reliability rating includes a means for automatically updating a person's reliability rating after passage of a predetermined length of time.

14. The system according to claim 1, wherein said means for calculating a reliability rating includes a means for automatically updating a person's reliability rating by excluding old information contained in the profile table from being used in the calculation.

15. The system according to claim 2, wherein said means for calculating a reliability rating includes a means for assessing a first type of penalty when a person exhibits a predetermined behavior, and a second type of penalty based on a ratio of a number of times a person removes himself or herself from a guest list to a number of times the person adds himself or herself to a guest list.

16. The system according to claim 15, wherein said predetermined behavior includes failing to attend an event after a person has added himself or herself to a guest list for the event, and failing to remove oneself from a guest list at least a predetermined length of time before an event the person does not attend.

17. The system according to claim 15, wherein said predetermined behavior includes submitting an unacceptable reason for either (1) failing to attend an event when a person is on the guest list, or (2) failing to remove oneself from a guest list at least a predetermined length of time before an event the person does not attend.

18. The system according to claim 1, further comprising a means for a host of an event to remove a person from a guest list for the event and to assess a penalty on the removed person, thereby lowering the calculated reliability rating for the removed person.

19. A software program for use with a computer system to manage guest lists for events, comprising:
a means for adding a person to a guest list for an event;
a means for accessing a database containing personal profiles of people using the system;
a means for calculating a reliability rating for a person based on information in the personal profiles contained on the database; and
a means for using said calculated reliability rating to determine whether a person is allowed to be added to a guest list for an event.

20. The software program according to claim 19,
further comprising a means for removing a person from a guest list;
wherein said personal profiles contained on the database include fields for recording a person's history of adding themselves to guest lists for events, removing themselves from such guest lists, and failing to attend such events;
further comprising a means for setting a reliability threshold for an event, and wherein said means for using said reliability rating comprises a means for comparing the calculated reliability rating for each person with said reliability threshold and preventing those persons having a reliability rating lower then said reliability threshold from adding themselves to the guest list for the event.

21. A method of managing guest lists for events, comprising:
receiving requests by persons desiring to be added to a guest list for an event;
maintaining a database containing history of use information for each person using the system;
calculating a reliability rating for a person based on the history of use information maintained on the database; and
using said calculated reliability rating to determine whether a person is allowed to be added to a guest list for an event.

22. The method according to claim 21, further comprising the steps of:
receiving requests by persons desiring to be removed from the guest list;
wherein said history of use information contained on the database includes a person's history of adding themselves to guest lists for events, removing themselves from such guest lists, and failing to attend such events; and
setting a reliability threshold for an event, and comparing the calculated reliability rating for each person with the reliability threshold and preventing those persons having a reliability rating lower then said reliability threshold from adding themselves to the guest list for the event.
